(19) United States
(12) Patent Application Publication
(10) Pub. No.: US 2004/0254728 A1
(43) Pub. Date: Dec. 16, 2004

(54) Collision warning system and method

(76) Inventor: George Vladimir Poropat, Queensland (AU)

Correspondence Address: CANTOR COLBURN, LLP, 55 GRIFFIN ROAD SOUTH, BLOOMFIELD, CT, 06002

(21) Appl. No.: 10/492,675

(22) PCT Filed: Oct. 25, 2002
(86) PCT No.: PCT/AU02/01451

(51) Int. Cl. G06F 17/10

(52) U.S. Cl. 701/301; 340/903

(57) ABSTRACT

The disclosed invention relates to a system for and a method of providing a collision warning to an operator of a vehicle. The disclosed system, which is operable in accordance with the disclosed method, includes a range gated visual imaging means and a processing means. The imaging means is operable to acquire a visual image of an object located within a detection zone whose location relative to the vehicle is known. The processing means is operable to process the image to determine the location of the object relative to the vehicle, determine whether the vehicle might collide with the object, and warn the operator if it is determined that the vehicle might collide with the object.

### FIELD OF THE INVENTION

This invention relates generally to a collision warning system and method. In particular, the invention relates to a system for and a method of providing a collision warning to an operator of a vehicle.

The invention has been developed primarily for alerting an operator of a vehicle such as a rotary or fixed-wing aircraft to the presence of an object such as an electrical power cable or telecommunications infrastructure which may lie in the path of the vehicle and will be described hereinafter with reference to this application, however it will be appreciated that the invention is not limited to this particular use.

### BRIEF DESCRIPTION OF THE PRIOR ART

The timely detection of objects which lie in the path of a vehicle such as a helicopter or an aeroplane is critical to the safe operation of such vehicles as it provides the vehicle operator with an opportunity to take appropriate evasive action to prevent a collision occurring between the vehicle and the detected objects.

Objects which lie in the path of a vehicle can be detected by a person using their sense of sight. Alternatively, artificial means such as radar, sonar, laser radar (lidar) or conventional imaging systems may be used. However, all of these suffer from limitations in their capacity to adequately detect objects.

For example, when a person's sense of sight is relied upon, the person may completely fail to detect an object or may only detect an object when it is too late to take evasive action to prevent the vehicle colliding with the object.

With regard to radar, sonar and laser radar systems, the relatively large amount of time required by these systems to scan an extended area which is proximal to the vehicle limits their ability to detect objects in a timely manner.

Conventional imaging systems on the other hand are capable of acquiring a large amount of information in a relatively short period of time, however these systems are deficient in a number of respects. For example, the significant amount of time that is often required to process the large amount of information acquired by these systems can prevent the timely detection of objects. Also, the information may not adequately disclose the presence of some objects which lie in the path of a vehicle. Additionally, some conventional imaging systems are unable to detect certain types of objects such as electrical power cables. Further, conventional imaging systems are generally unable to obtain the data that is required to determine the location of an object relative to a vehicle so that a proper assessment of the likelihood of a collision can be made.

It is an object of the present invention to provide a system for and a method of providing a collision warning to an operator of a vehicle.

It is a further object of the present invention to overcome, or at least substantially ameliorate, one or more of the deficiencies associated with the prior art.

Other objects and advantages of the present invention will become apparent from the following description, taken in connection with the accompanying drawings, wherein, by way of illustration and example, an embodiment of the present invention is disclosed.

### SUMMARY OF THE INVENTION

According to a first aspect of the present invention there is provided a system for providing a collision warning to an operator of a vehicle, the system including a range gated visual imaging means operable to acquire a visual image of an object located within a detection zone whose location relative to the vehicle is known, and a processing means operable to process the image to determine the location of the object relative to the vehicle, determine whether the vehicle might collide with the object, and warn the operator if it is determined that the vehicle might collide with the object.

The term “visual image” as used herein is to be interpreted as meaning an image which is obtained through the detection of light such as visible, infrared or ultraviolet light, and which may be represented in a visual or non-visual form. For example, in the case of the image being represented in a visual form the image may be displayed as an analogue image on a computer monitor so that a person is able to visually discern the image. In the case of the image being represented in a non-visual form the image may for example be stored in a computer memory as digital data.

Preferably, the imaging means is operable to either maintain the detection zone at a constant location relative to the vehicle or vary the location of the detection zone relative to the vehicle. The location of the detection zone relative to the vehicle may be varied in response to acceleration or deceleration of the vehicle. In particular, the location of the detection zone relative to the vehicle may be varied such that the detection zone is moved away from the vehicle in response to acceleration of the vehicle, or moved towards the vehicle in response to deceleration of the vehicle. The location of the detection zone relative to the vehicle may be varied in response to manoeuvres which are being or will are to be performed by the vehicle.

Preferably, the imaging means is operable to vary the size of the detection zone. The size of the detection zone may be proportional to the distance between the vehicle and the detection zone.

According to a second aspect of the present invention there is provided a method of providing a collision warning to an operator of a vehicle, the method including the steps of:

(i) operating a range gated visual imaging means to acquire a visual image of an object located within a detection zone whose location relative to the vehicle is known;

(ii) processing the image to determine the location of the object relative to the vehicle and whether the vehicle might collide with the object; and

(iii) warning the operator if it is determined that the vehicle might collide with the object.

Preferably, the location of the detection zone relative to the vehicle is constant or varied. The location of the detection zone relative to the vehicle may be varied in response to acceleration or deceleration of the vehicle. In particular, the location of the detection zone relative to the vehicle may be varied such that the detection zone is moved away from the vehicle in response to acceleration of the vehicle, or moved towards the vehicle in response to deceleration of the vehicle. The location of the detection zone relative to the vehicle may be varied in response to manoeuvres which are being or are to be performed by the vehicle.

Preferably, the size of the detection zone is varied. The size of the detection zone may be proportional to the distance between the vehicle and the detection zone.

### BRIEF DESCRIPTION OF THE DRAWINGS

In order that the invention may be more fully understood and put into practice, a preferred embodiment thereof will now be described with reference to the accompanying drawings, in which:

FIG. 1 is a block diagram of a collision warning system according to an embodiment of the present invention;

FIG. 2 is a conceptual diagram which represents a vehicle carrying the collision warning system illustrated in FIG. 1 and a detection zone which lies in the path of the vehicle and which is imaged by the system;

FIG. 3 is a conceptual diagram which is similar to FIG. 2 and which illustrates how a plurality of different detection zones can be sequentially imaged by the collision warning system;

FIG. 4 is a conceptual diagram which is similar to FIG. 2 and which illustrates the detection zones imaged by the collision warning system at two different locations of the vehicle; and

FIG. 5 is a conceptual diagram which is similar to FIG. 2 and which illustrates the situation where a portion of an electrical power cable is located within a detection zone imaged by the collision warning system at a particular instant in time.

### DETAILED DESCRIPTION OF THE PREFERRED EMBODIMENT

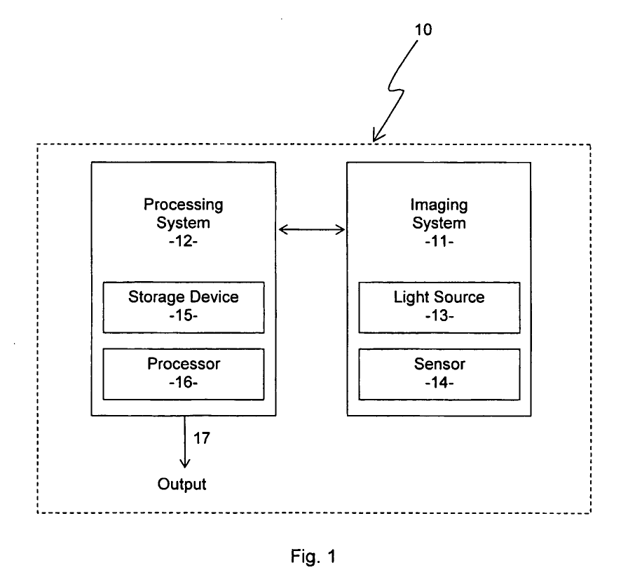

Referring to FIG. 1, a vehicle such as a helicopter or an aeroplane carries a collision warning system 10 having a range gated visual imaging system 11 and a processing system 12. The collision warning system 10 is operable to rapidly detect objects which lie in the path of the vehicle by repeatedly imaging the space into which the vehicle moves. If the collision warning system 10 determines that a collision is likely to occur between the vehicle and a detected object, the system 10 outputs a timely warning to the vehicle operator so that the operator has sufficient time to take appropriate evasive action to prevent a collision from occurring between the vehicle and the detected object. The collision warning system 10 is able to vary the location and size of the space being imaged so as to vary the timeliness of the warning to suit the speed of travel of the vehicle and manoeuvres which the vehicle is undertaking or may undertake.

The imaging system 11 includes a light source 13 and a sensor 14. The imaging system 11 is operable to acquire an image of objects which are located within a predetermined range of distances from the sensor 14 and within a field of view associated with the sensor 14. The range of distances combined with the field of view of the sensor 14 defines a detection zone whose location relative to the sensor 14 is known by the collision warning system 10. Since the location of the detection zone relative to the sensor 14 is known it follows that the collision warning system 10 is able to readily determine the location of objects, which appear in an image, relative to the sensor 14. As the sensor 14 is carried by the vehicle, the location of the objects relative to the sensor 14 corresponds to the location of the objects relative to the vehicle.

The light source 13 is operated to emit pulses of visible, ultraviolet or infrared light which are directed towards the detection zone. The light pulses may for example be emitted by a conventional light source or, alternatively, by a device such as a laser. In the case of a conventional light source or in the case where the light is infrared, ultraviolet etc. and emitted by a laser, the light pulses are emitted as a broad beam covering the field of view of the sensor 14. The duration of the light pulses define the required maximum and minimum distances of the range gate of the imaging system 11 and thus, in conjunction with the timing of the gating of the sensor 14, the detection zone imaged by the sensor 14.

The sensor 14 is in the form of a light sensor which is primarily sensitive to light emitted by the light source 13. The sensor 14 may, for example, be a camera. The sensor 14 is operated to detect light emitted from the light source 13 which is reflected towards the sensor 14 from an object located within the detection zone. The aforementioned operation of the sensor 14 includes enabling or gating the sensor 14 to detect light for a short period of time after each light pulse is emitted by the light source 13. The gating of sensor 14 is delayed for a short period of time after each pulse of light is emitted by the light source 13. The length of the delay is approximately equal to the time required for a pulse of emitted light to travel from the light source 13 to the detection zone and for a portion of the emitted light that is reflected towards the sensor 14 from an object located within the detection zone to reach the sensor 14. The time delay in gating the sensor 14 enables the distance between the detection zone and the sensor 14, and therefore the distance between the sensor 14 and an object contained within the detection zone, to be calculated. The distance between the sensor 14 and the detection zone is calculated as the speed of light divided by the time delay. The duration of time for which the sensor 14 is gated is such that the portion of an emitted light pulse that is reflected from within the detection zone and received by the sensor 14 will dominate the image acquired by the imaging system 11.

The imaging system 11 can vary the distance between the detection zone and the sensor 14 by changing the duration of the time delay prior to gating the sensor 14. Thus, by reducing the time delay the detection zone is brought closer to the sensor 14, while increasing the time delay has the effect of moving the detection zone further away from the sensor 14.

The imaging system 11 can also vary the size of the detection zone by changing the duration of the time delay prior to gating the sensor 14, changing the duration of time for which the sensor 14 is gated, or changing the field of view of the sensor 14.

The operation of the optical range gated visual imaging system 11 will not be discussed any further as such systems and their operation are well known in the art.

The processing system 12 includes a storage device 15, a processor 16 and an output means 17. The processing system 12 processes images which are acquired by the imaging system 11 together with other data associated with the vehicle which carries the collision warning system 10. This other data may relate to the speed of the vehicle and the manoeuvring capabilities of the vehicle. In particular the processing system 12 processes the images to detect objects which appear in the images and to determine their location relative to the vehicle. The processing system 12 also determines the likelihood of the vehicle colliding with the detected objects. If the processing system 12 determines that the vehicle is likely to collide with an object, a suitable warning signal is output from the output means 17.

The storage device 15 is used to store the image data acquired by the imaging system 12 and the vehicle data.

A program, which is executed by the processor 16, processes the image and vehicle data which is stored on the storage device 15. The program uses a suitable algorithm such as the Hough transform to detect and characterise linear objects such as electrical power cables and telecommunications infrastructure such as antenna towers which may appear in the image. The program then determines the locations of the detected objects and the likelihood of the vehicle colliding with the objects. If the program determines that a collision is likely to occur between the vehicle and a detected object, the program causes a suitable warning signal to be output from the output means 17. The warning signal may include information relating to the location and extent of the detected objects relative to the vehicle. The warning signal from the output means 17 is presented to the vehicle operator, which may for example be a person or an automated vehicle controlling system such as an autopilot. In the case where the warning signal is output to an autonomous vehicle controlling system, the warning signal alerts the autonomous vehicle controlling system to the need for evasive action. The timing of the warning signal is such that there is sufficient time for the vehicle operator to act upon the warning signal so that a collision is avoided.

The collision warning system 10 is able to adjust the size and location of the detection zone relative to the sensor 14 (and therefore the vehicle) in response to changes in the vehicle speed or manoeuvres which the vehicle is undertaking or may undertake. This enables the collision warning system 10 to provide adequate warning of a likely collision under a range of circumstances. For example, in the case where the speed of the vehicle changes or the nature of the manoeuvres undertaken by the vehicle change, the collision warning system 10 suitably adjusts the size and location of the detection zone relative to the sensor 14 to ensure that the vehicle operator will have sufficient time to take evasive action and prevent a collision from occurring should a warning signal be generated. Thus, the detection zone may for example be moved away from the vehicle in response to acceleration of the vehicle, and moved towards the vehicle in response to deceleration of the vehicle. Also, if it is known that the vehicle requires a certain amount of space in which to manoeuvre, the size and location of the detection zone can be adjusted so that the imaging system 11 is able to acquire an image of the space into which the vehicle may manoeuvre. In this way, the system 10 is able to maintain a map of all areas into which the vehicle may manoeuvre.

Either prior to or during the commencement of motion of the vehicle the collision warning system 10 acquires a three-dimensional image of a detection zone into which the vehicle will initially move and stores the image in the storage device 15. The processor 16 then processes the stored image to detect any objects which might appear in the image. The processor 16 then determines the location of any detected objects relative to the vehicle and the likelihood of a collision occurring between the vehicle and the detected objects. A warning signal is output from the output means 17 if the system 10 determines that a collision between the vehicle and a detected object is likely to occur.

As the vehicle moves, the system 10 acquires an image from a further detection zone which is located beyond the initial detection zone such that the further detection zone overlaps with the initial detection zone. The processor 16 then processes the images acquired from the further detection zone in the same manner as the image from the initial detection zone. Data relating to a detection zone through which the vehicle has passed or which the vehicle is unable to pass through is deleted from the storage device 15. The various steps commencing with the acquisition of an image from a detection zone through to the deletion of data from the storage device 15 are repeated.

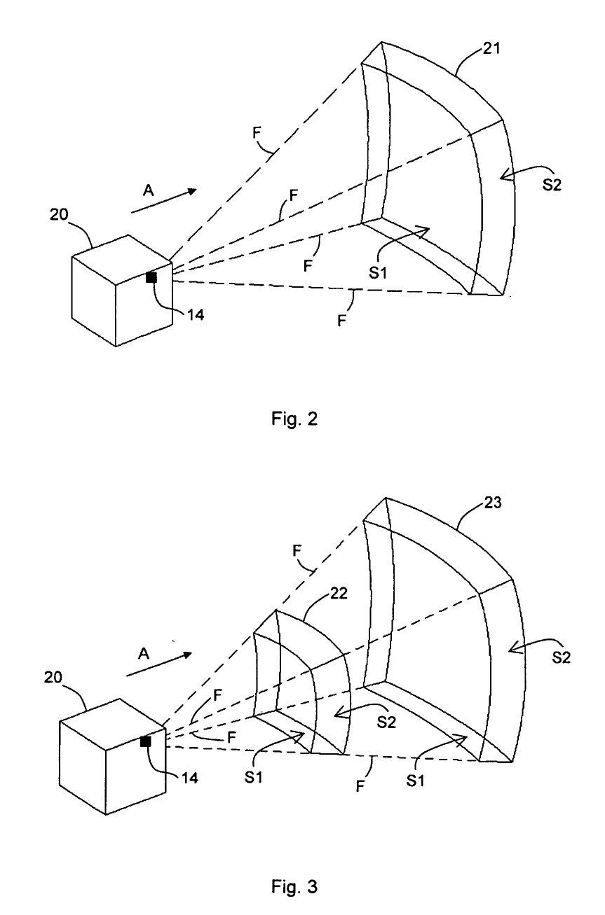

Referring to FIG. 2, a vehicle 20 carrying the collision warning system 10 moves in a direction indicated by arrow A. At a particular instant of time, the system 10 acquires an image from a detection zone 21, which lies in the path of the vehicle 20, and stores the acquired image in the storage device 15. The detection zone 21 is roughly defined by the volume bounded by the field of view (indicated by lines F) of the sensor 14 and two spaced curved surfaces S1 and S2 whose centres of curvature coincide with the location of the sensor 14. The curved surfaces S1 and S2 define a range of distances from the sensor 14. The processing system 12 processes the image acquired by the imaging system 11 together with other data associated with the vehicle 20 such as the speed of the vehicle 20 and the manoeuvring capabilities of the vehicle 20. If the processing system 12 determines that there is a likelihood of a collision occurring between the vehicle 20 and any detected objects, the processing system 12 outputs a suitable warning signal from the output means 17. The timing of the warning signal is such that the vehicle operator has sufficient time to act upon the warning signal so as to avoid a collision occurring between the vehicle 20 and the detected objects. As the vehicle 20 moves, the collision warning system 10 repeats the above process. It is preferred that the further detection zones overlap each other, however the detection zones may be adjacent to each other.

Referring to FIG. 3, the vehicle 20 is about to or has just commenced motion in the direction indicated by arrow A. Either prior to or during the commencement of motion of the vehicle 20 the system 10 initially acquires images from a detection zone which includes a plurality of smaller detection zones (such as detection zones 22 and 23) located at various distances and within a specified maximum distance from the vehicle 20. The system 10 stores the images acquired from the various smaller detection zones in the storage device 15. The acquired images provide the vehicle operator with an initial map of objects which may lie in the path of the vehicle 20. If the system 10 acquires the images during the commencement of motion of the vehicle 20, the detection zone which is closest to the vehicle 20 is imaged prior to those detection zones which are located further away from the vehicle 20. For example, the system 10 will image detection zone 22 before detection zone 23. Although not illustrated, there are intervening detection zones between the vehicle 20 and the detection zones 22, 23. Once the initial map has been acquired by the system 10 and the vehicle 20 begins to move, the imaging system 12 begins acquiring images from further detection zones which lie in the path of travel of the vehicle 20. Images from the further detection zones are stored in the storage device 15. Alternatively, the system 10 may continue to acquire images from a plurality of detection zones located at various distances and within a specified maximum distance from the vehicle 20. If the processing system 12 determines that a collision is likely to occur between the vehicle 20 and a detected object, the processing system 12 outputs a timely warning signal from the output means 17.

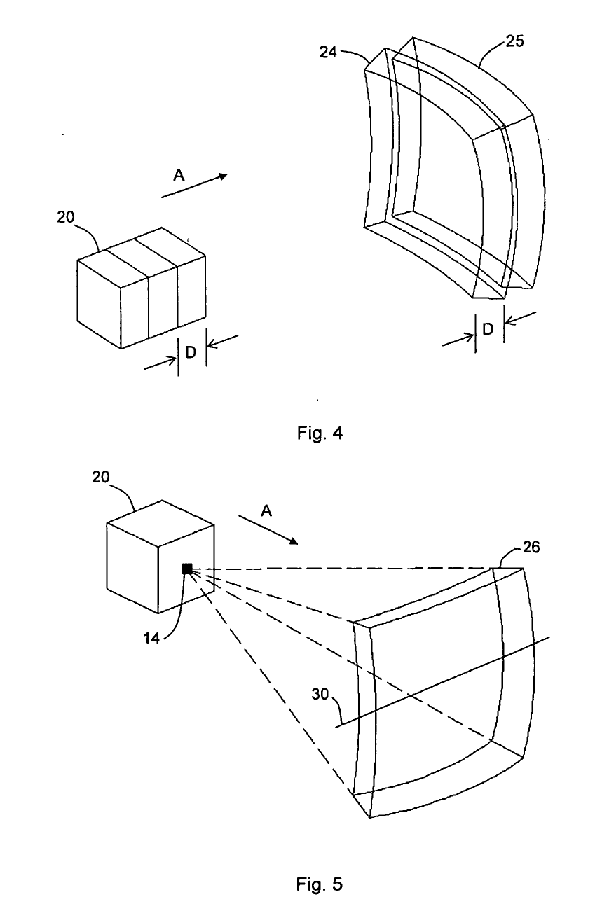

Referring to FIG. 4, the vehicle 20 is moving in the direction indicated by arrow A and is displaced by a distance D from the location where the system 10 acquired an image from a detection zone 24. Following the displacement of the vehicle 20 by the distance D the system 10 acquires a new image from a detection zone 25, which is also displaced from the previous detection zone 24 by the distance D, and stores the new image in the storage device 15. The distance D is equal to the distance between the spherical surfaces which bound detection zone 24 so that detection zone 25 is adjacent to detection zone 24. However, the distance D may be such that the detection zones 24 and 25 overlap or are spaced apart. If the processing system 12 determines that a collision is likely to occur between the vehicle 20 and a detected object, the processing system 12 outputs a timely warning signal from the output means 17. The system 10 continues to acquire images from further detection zones as the vehicle 20 moves.

In FIG. 5, the vehicle 20 moves in the direction indicated by arrow A and the collision warning system 10 acquires an image from a detection zone 26 within which an electrical power cable 30 is located. The processing system 12 processes the image acquired by the imaging system 11 and determines the likelihood that the vehicle 20 will collide with the cable 30. If the processing system 12 determines that the vehicle 20 is likely to collide with the cable 30, the processing system 12 outputs a timely warning signal from the output means 17.

The foregoing describes only one embodiment of the present invention, and modifications, obvious to those skilled in the art, can be made thereto without departing from the scope of the present invention.

For example, a different algorithm to the Hough transform may be used to detect objects which appear in images acquired by the imaging system 11.

1. A system for providing a collision warning to an operator of a vehicle, the system including a range gated visual imaging means operable to acquire a visual image of an object located within a detection zone whose location relative to the vehicle is known, and a processing means operable to process the image to determine the location of the object relative to the vehicle, determine whether the vehicle might collide with the object, and warn the operator if it is determined that the vehicle might collide with the object.

2. The system of claim 1, wherein the imaging means is operable to maintain the detection zone at a constant location relative to the vehicle.

3. The system of claim 1, wherein the imaging means is operable to vary the location of the detection zone relative to the vehicle.

4. The system of claim 3, wherein the location of the detection zone relative to the vehicle is varied in response to acceleration or deceleration of the vehicle.

5. The system of claim 4, wherein the location of the detection zone relative to the vehicle is varied such that the detection zone is moved away from the vehicle in response to acceleration of the vehicle.

6. The system of claim 4, wherein the location of the detection zone relative to the vehicle is varied such that the detection zone is moved towards the vehicle in response to deceleration of the vehicle.

7. The system of claim 3, wherein the location of the detection zone relative to the vehicle is varied in response to manoeuvres which are being or are to be performed by the vehicle.

8. The system of claim 1, wherein the imaging means is operable to vary the size of the detection zone.

9. The system of claim 8, wherein the size of the detection zone is proportional to the distance between the vehicle and the detection zone.

10. A method of providing a collision warning to an operator of a vehicle, the method including the steps of:
(i) operating a range gated visual imaging means to acquire a visual image of an object located within a detection zone whose location relative to the vehicle is known;
(ii) processing the image to determine the location of the object relative to the vehicle and whether the vehicle might collide with the object; and
(iii) warning the operator if it is determined that the vehicle might collide with the object.

11. The method of claim 10, wherein the location of the detection zone relative to the vehicle is constant.

12. The method of claim 10, wherein the location of the detection zone relative to the vehicle is varied.

13. The method of claim 12, wherein the location of the detection zone relative to the vehicle is varied in response to acceleration or deceleration of the vehicle.

14. The method of claim 13, wherein the location of the detection zone relative to the vehicle is varied such that the detection zone is moved away from the vehicle in response to acceleration of the vehicle.

15. The method of claim 13, wherein the location of the detection zone relative to the vehicle is varied such that the detection zone is moved towards the vehicle in response to deceleration of the vehicle.

16. The method of claim 12, wherein the location of the detection zone relative to the vehicle is varied in response to manoeuvres which are being or are to be performed by the vehicle.

17. The method of claim 10, wherein the size of the detection zone is varied.

18. The method of claim 17, wherein the size of the detection zone is proportional to the distance between the vehicle and the detection zone.
